(19) United States
(12) Patent Application Publication
(10) Pub. No.: US 2011/0131737 A1
(43) Pub. Date: Jun. 9, 2011

(54) SECURIZATION WITH DYE DIFFUSION TRANSFER LAMINATES

(75) Inventors: Carlo Uyttendaele, Mortsel (BE); Ingrid Geuens, Emblem (BE)

(73) Assignee: AGFA-GEVAERT N.V., Mortsel (BE)

(21) Appl. No.: 13/058,766

(22) PCT Filed: Oct. 15, 2009
(86) PCT No.: PCT/EP2009/063461

§ 371 Date: Feb. 11, 2011

Related U.S. Application Data
(60) Provisional application No. 61/111,452, filed on Nov. 5, 2008.

(30) Foreign Application Priority Data
Nov. 4, 2008 (EP) 08168228.8

(51) Int. Cl. D06P 5/24; B32B 37/00; B32B 38/14

(52) U.S. Cl. 8/467; 156/182; 156/277

(57) ABSTRACT

A security laminate containing a dye diffusion transfer image receptor layer comprising a polymeric mordant for dyes on a support having a laser engraved first dye diffusion transfer image or a laser marked dye diffusion transfer image receptor layer in an area lacking the first dye diffusion transfer image. Methods for manufacturing and securing security document precusors are also disclosed.

### TECHNICAL FIELD

This invention relates to the security of information or data carriers, more particularly to securing security documents, such as security cards and passports, so that the identification data is not altered or modified and that the documents cannot thus be reused fraudulently.

### BACKGROUND ART

Security laminates are traditionally used to protect documents or packages to ensure that the underlying items are not altered by containing an authentification feature making them difficult to counterfeit. Security laminates are particularly useful on identification cards such as driver's licenses, ID-cards and passports, and on other important documents such as certificates of title. Security laminates are also useful as tamper proof seals on medications, video cassettes, and compact discs.

Five features are particularly important when producing and using security laminates. First, once applied to an article it is important that the laminate is difficult to remove to ensure that the underlying item is not altered or subjected to tampering. Second, a desirable laminate is difficult if not impossible to duplicate by counterfeiters. Third, if tampering occurs it is important to quickly and accurately recognize an altered or counterfeit laminate. Fourth, it is important that manufacturing costs of the laminates are not prohibitively expensive. Fifth, when used on articles such as identification cards, it is important that the laminate has sufficient durability to withstand harsh treatment.

Security documents are widely used for various applications such as identification purposes (ID cards), financial transfers (credit cards), social security, etc. Such cards typically consist of a laminated structure consisting of various plastic layers wherein one or more layers carry information, e.g. alphanumeric information, logos and a picture of the card holder. Security Documents wherein the user can store digital information are also known, e.g. cards comprising a magnetic strip, optically recordable cards or cards comprising an electronic chip, so-called ‘smart cards’.

Information visible to the human eye can be added to a card using various imaging techniques such as inkjet, electrophotography, laser marking, laser engraving, dye sublimation, dye diffusion transfer imaging and silver diffusion transfer imaging. In literature, laser engraving is often incorrectly used for laser marking. While carbonization of material occurs in laser marking, in laser engraving the material is ablated.

The imaging techniques can be categorized into “additive” imaging techniques, e.g. inkjet, and “subtractive” imaging techniques, e.g. laser engraving. Often in falsifying security cards, the addition of information has been proven to be easier than the subtraction of information. For example, it is possible to completely change a photograph by adding more hair, or a moustache or glasses etc.

One approach to prevent forgery is to include the same information in the form of a positive image and also in the form of a reverse or inverted image, i.e. a negative image on the same identification document. This makes it possible to compare the two images and see very rapidly if there has been a forgery. That is because while it is very easy to add darkened areas to a picture printed in positive to modify that picture, it is on the other hand much more difficult to do so with the reverse image, as that would require adding areas in a complementary colour. To take the example of laser marking, whilst the positive image can be laser marked to add e.g. dark hair, these same parts cannot be added on the negative as that would mean adding white, the complementary colour. Adding white to the negative is impossible, because as the negative is printed by laser marking, that would require erasing the areas that appear black. Erasing black areas can be done by laser engraving but requires different properties of the material than laser marking. An example of this approach is described by WO 2008/084315 (AXALTO) for a secure identification document comprising a first set of identification data and a second set of identification data obtained by duplicating the first set of identification data in the form of a reverse image of the first set of identification data.

Since methods for falsification and counterfeiting of security documents also continue to develop and improve, it remains a constant battle to protect security documents against falsification and counterfeiting by developing new security features and methods of securing such documents.

### SUMMARY OF THE INVENTION

It was surprisingly found that a dye image in a dye diffusion transfer image receptor layer comprising a polymeric mordant could be laser engraved, while no laser engraving appeared to be possible with dye images obtained with other imaging techniques such as thermal dye sublimation and inkjet which together represent the most commonly used techniques for manufacturing colour images in security documents. Furthermore, it was observed that the same dye diffusion transfer image receptor layer could be laser marked in an area not containing a dye diffusion transfer image. The unseen fact that a single layer can be used for laser marking as well as for laser engraving opens up a range of possibilities for the securization of security documents.

In order to overcome the problems of falsification or detection of falsification described above, preferred embodiments of the present invention provide a security laminate as defined by claim 1.

Further advantages and embodiments of the present invention will become apparent from the following description.

### DISCLOSURE OF INVENTION

### Brief Description of Figures in the Drawings

FIG. 1 shows an example of photograph forgery by adding darkened areas on a security card. The original security card 1 contains data about the identity of the holder in a text area 2 and an image 3. The original image 3 of the security card 1 has been modified by the addition of hair and a moustache, so that there is a new forged image 3A on the security card 1A.

FIG. 2 shows a security card 1 containing data about the identity of the holder in a text area 2 and a dye diffusion transfer image 3 which was laser engraved to have microprint 4.

FIG. 3 shows a schematic sectional view of a security laminate 30 having a support 31 bearing a dye diffusion transfer image 35 in a dye diffusion transfer receptor layer 32 wherein material 34 has been removed by laser engraving and a protective layer 33 was sealed to the layer 32.

FIG. 4 shows a security laminate 40 containing data about the identity of the holder in a text area 41, a dye diffusion transfer image 42 and its inverted laser engraved dye diffusion transfer image 43.

FIG. 5 shows a security laminate 50 containing data about the identity of the holder in a text area 51, a dye diffusion transfer image 52 with its laser engraved inverted dye diffusion transfer image 53 located inside the dye diffusion transfer image 52.

FIG. 6 shows a security laminate 60 containing data about the identity of the holder in a text area 61, a dye diffusion transfer image 62 and a laser marked inverted ghost image 63 outside the area of the dye diffusion transfer image 62.

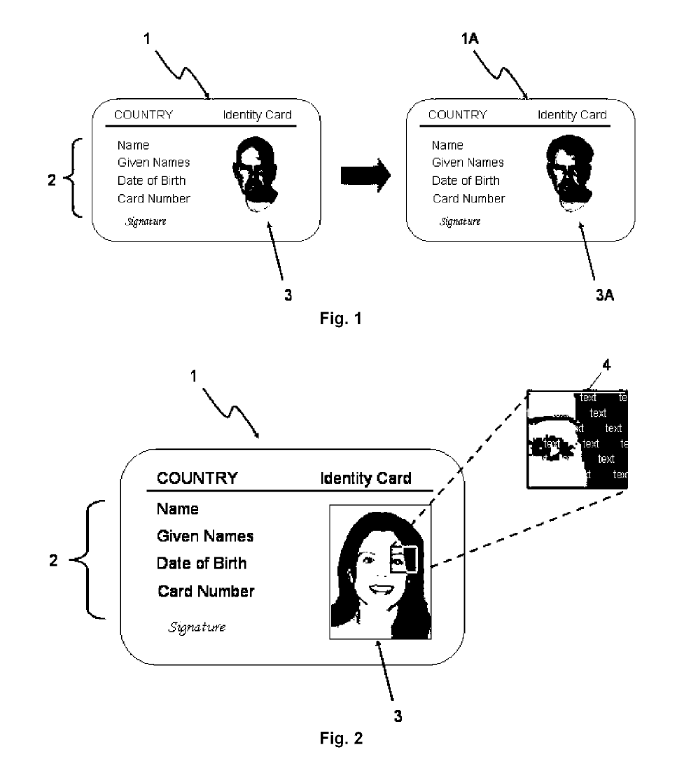

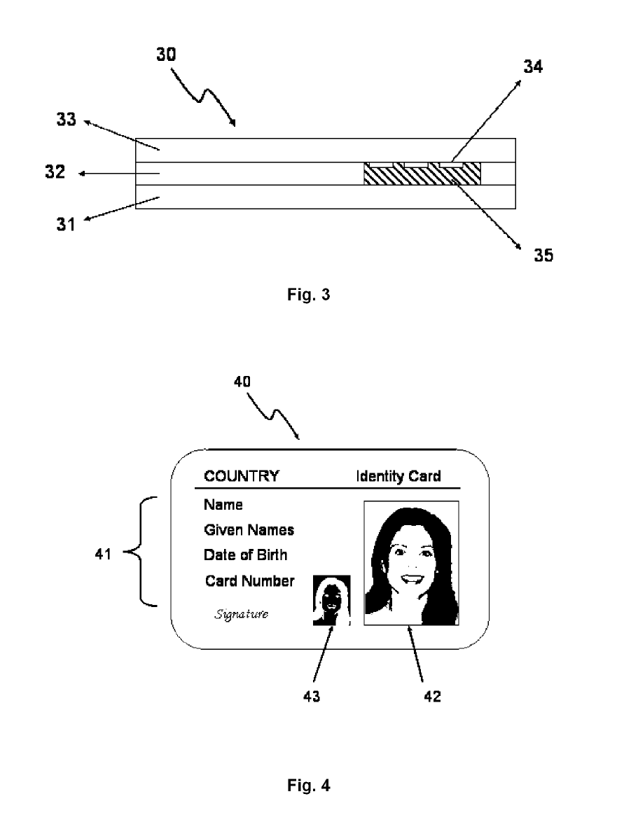

### DEFINITIONS

The definitions of security features correspond with the normal definition as adhered to in the “Glossary of Security Documents—Security features and other related technical terms” as published by the Consilium of the Council of the European Union on Aug. 25, 2008 (Version: v.10329.02.b.en) on its website: http://www.consilium.europa.eu/prado/EN/glossaryPopup.html.

The term “ghost image”, as used in the preferred embodiments of the present invention, means a semi-translucent smaller version of an image, usually a photo image of a person, on a security document.

The terms “dye diffusion transfer image” and “image” as used in the preferred embodiments of the present invention, encompasses all types of information such as drawings, photos, patterns, barcodes and textual information.

“PC” is an abbreviation for polycarbonate.

“PET” is an abbreviation for polyethylene terephthalate.

“PETG” is an abbreviation for polyethylene terephthalate glycol, the glycol indicating glycol modifiers which are incorporated to minimize brittleness and premature aging that occur if unmodified amorphous polyethylene terephthalate (APET) is used in the production of cards.

### Security Laminates

A security laminate according to the present invention contains a dye diffusion transfer image receptor layer comprising a polymeric mordant for dyes on a support having a laser engraved dye diffusion transfer image or a laser marked dye diffusion transfer image receptor layer in an area lacking a dye diffusion transfer image.

In a preferred embodiment of the security laminate according to the present invention, the receptor layer further contains an electroless deposition catalyst. The presence of an electroless deposition catalyst has several advantages including the thermal stabilization of the dye diffusion transfer image and the possibility of using the receptor layer also for silver diffusion transfer imaging.

In a preferred embodiment of the security laminate according to the present invention, the security laminate contains a ghost image made by laser marking in an area of the receptor layer lacking a dye diffusion transfer image.

In another preferred embodiment of the security laminate according to the present invention, the security laminate contains an inverted ghost image by laser marking in an area of the receptor layer lacking the first dye diffusion transfer image. An inverted ghost image has the advantage over a ghost image that it is not possible to remove image details added to a positive image, since this would imply laser engraving and not laser marking. The concept of an inverted ghost image is illustrated in FIG. 6.

In a preferred embodiment of the security laminate according to the present invention, the first dye diffusion transfer image is laser engraved with an image differing from the first dye diffusion transfer image, more preferably an image including microprint or nanoprint. The presence of microprint or nanoprint makes falsification very difficult because the addition of e.g. hair by inkjet to the laser engraved dye diffusion transfer image would cause the engraved microprint or nanoprint to be filled up with ink. Printing an inkjet dye image on a layer above the laser engraved dye diffusion transfer image would mask and interrupt the engraved microprint or nanoprint.

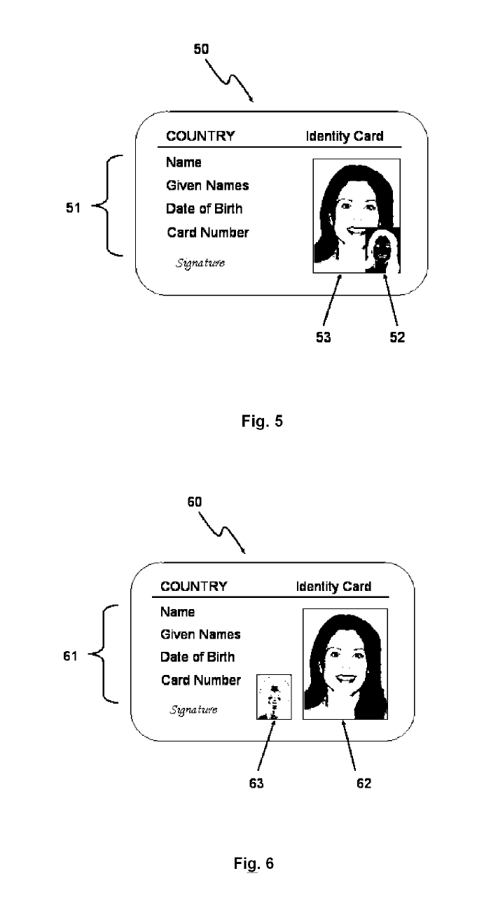

In a preferred embodiment of the security laminate according to the present invention, the support bears a second dye diffusion transfer image of uniform density which is laser engraved with the inverted image of the first dye diffusion transfer image. This concept is illustrated by FIG. 4. In another embodiment, such a laser engraved inverted image is located in the first dye diffusion transfer image as shown by FIG. 5.

In preferred embodiment, the security laminate according to the present invention contains both a containing a laser engraved dye diffusion transfer image and a laser marked image in the dye diffusion transfer image receptor layer in an area lacking the dye diffusion transfer image.

The security laminate according to the present invention is preferably used for protecting security documents and security document precursors, but may also be used to protect packages and articles of value requiring an authentification feature for making them difficult to counterfeit, such as medications, perfumes, video cassettes, CDs, and DVDs.

### Security Documents and Security Document Precursors

A security document precursor according to the present invention includes at least one security laminate according to the present invention. In one embodiment, the security laminate is present on both the front side and the backside of the security document precursor, which is preferably a laser marked security document precursor.

A security document precursor may become a security document on lamination of the security laminate. However, a security document precursor only becomes a security document when the final security features, images and information are added to the security document precursor, and the document can be handed over to the end-user. If e.g. an additional layer containing a hologram must still be added on the backside of the document having the security laminate on the front side, then the document is considered a security document precursor. In the text below we will refer to a security document precursor, but it includes and addresses also a security document if the above conditions are fulfilled. A document having neither an image on the front side nor the backside cannot be considered a security document.

A security document precursor may itself be composed of one or more security document precursors.

The security laminate according to the present invention can itself be considered to be a security document precursor if for completion to a security document no other layers or laminates containing an image are applied and at least one protective polymeric layer or laminate containing no image is applied on the dye diffusion transfer image receptor layer.

In a preferred embodiment of the security laminate according to the present invention is laminated on a laser marked security document precursor, which is preferably laser marked in a part containing a laser marking additive and a polymer selected from the group consisting of polyester, polycarbonate and polyvinylchloride.

In one embodiment of the security laminate according to present invention is laminated on a security document precursor with the side of the support containing the dye diffusion transfer image receptor layer with a dye diffusion transfer image. The support is then preferably a transparent support.

In a preferred embodiment of the security document precursor according to the present invention, at least one protective layer or laminate is applied on the dye diffusion transfer image receptor layer. In a more preferred embodiment the at least one protective layer or laminate applied on the dye diffusion transfer image receptor layer is transparent and the support is opaque.

The security document according to the present invention is preferably an identification card selected from the group consisting of an identity card, a security card, a driver's licence card, a social security card, a membership card, a time registration card, a bank card, a pay card and a credit card. In a preferred embodiment, the security document according to the present invention is a personal identity card.

The security document according to the present invention may be a “smart card”, meaning an identification card incorporating an integrated circuit as a so-called electronic chip. In a preferred embodiment the security document is a so-called radio frequency identification card or RFID-card.

A large set of security cards is preferably prepared on a large carrier of information such as a web or sheet by a step and repeat process, after which the information carrier is cut into multiple items with the appropriate dimensions each representing a personal ID card, preferably according to the format specified by ISO/IEC 7810. ISO 7810 specifies three formats for identification cards: ID-1 with the dimensions 85.60 mm×53.98 mm, a thickness of 0.76 mm is specified in ISO 7813, as used for bank cards, credit cards, driving licences and smart cards; ID-2 with the dimensions 105 mm×74 mm, as used in e.g. French and German identity cards, with typically a thickness of 0.76 mm; and ID-3 with the dimensions 125 mm×88 mm, as used for passports and visa's. When the security cards include one or more contactless integrated circuits then a larger thickness is tolerated, e.g. 3 mm according to ISO 14443-1.

### Dye Diffusion Transfer Receptor Layers

Photographic diffusion transfer processes have been known for several years and are summarized e.g. in Imaging Systems by Kurt I. Jacobson and Ralph E. Jacobson (1977) The Focal Press.

Furthermore, it has also in extenso been described for security applications in Chapter 17 of “Identification Security Systems Based on Silver Diffusion Transfer Imaging” by L. L. Vermeulen in Optical Document Security. Edited by VAN RENESSE, Rudolf L. Norwood, Mass.: ARTECH HOUSE, INC., 1994. ISBN 0890066191.

In a black-and-white DTR-process (Diffusion Transfer Reversal process), also called silver diffusion transfer, a silver salt complex is image-wise transferred by diffusion from an image-wise exposed silver halide emulsion layer to an image-receiving material wherein, with the aid of a developing agent and promoted by electroless deposition catalysts, i.e. so-called development nuclei, the silver salt complexes are reduced to silver in a pattern opposite the exposing image.

In dye diffusion transfer processes, an image-dye-providing substance is associated with a silver halide emulsion. An image-dye-providing substance, which provides a positive transferred image in an image-receiving material as a function of development of a conventional negative silver halide emulsion, is referred to as positive-working. Likewise, an image-dye-providing substance which provides a negative transferred image in an image-receiving layer as a function of development of a conventional negative silver halide emulsion, is referred to as negative working.

Dye-diffusion systems operating with photosensitive silver halide can be carried out in a number of ways, but they are all based on the same principle, i.e. the alteration in the mobility of a dye or dye-forming structural moiety of a compound controlled by the image-wise reduction of silver compounds to silver.

The coating of the dye diffusion transfer image receptor layer on the support proceeds preferably with slide hopper coater or curtain coater known to those skilled in the art.

### Polymeric Mordants and Dyes

The security laminate according to the present invention includes a polymeric mordant for dyes in the dye diffusion transfer image receptor layer on the support.

The polymeric mordant in the diffusion transfer image receptor layer is chosen depending upon the dye to be mordanted. If acid dyes are to be mordanted, the receptor layer can be composed of or contain basic polymeric mordants such as polymers of amino-guanidine derivatives of vinyl methyl ketone such as described in U.S. Pat. No. 2,882,156 (KODAK), and basic polymeric mordants and derivatives, e.g. poly-4-vinylpyridine, the 2-vinylpyridine polymer metho-p-toluene sulphonate and similar compounds described in U.S. Pat. No. 2,484,430 (KODAK), and polymeric mordants described in U.S. Pat. No. 4,266,044 (AGFA).

Suitable polymeric mordants also include e.g. guanylhydrazone derivatives of acyl styrene polymers, as described by U.S. Pat. No. 3,740,228 (AGFA).

Effective polymeric mordants include long-chain quaternary ammonium or phosphonium compounds or ternary sulphonium compounds, e.g. those described in U.S. Pat. No. 3,271,147 (KODAK), and cetyltrimethyl-ammonium bromide. Certain metal salts and their hydroxides that form sparingly soluble compounds with the acid dyes may be used too. The dye mordants may be dispersed in a hydrophilic binder in the dye diffusion transfer image receptor layer, e.g. in gelatin, polyvinylpyrrolidone or partly or completely hydrolysed cellulose esters.

Other suitable cationic polymeric mordants for fixing anionic dyes are disclosed in U.S. Pat. No. 4,186,014 (AGFA),

In the preferred embodiment, the polymeric mordant is a basic compound and the dyes are anionic dyes. Suitable anionic dyes include e.g. sulphinic acid salt dyes that are image-wise released by a redox-reaction described as described in EP 0004399 A (AGFA) and U.S. Pat. No. 4,232,107 (AGFA).

Other suitable dyes are those disclosed in U.S. Pat. No. 5,037,731 (AGFA), U.S. Pat. No. 4,855,223 (AGFA), U.S. Pat. No. 4,777,124 (AGFA), U.S. Pat. No. 4,605,613 (AGFA) incorporated herein as a specific reference.

Generally, good results are obtained when the dye diffusion transfer image receptor layer, which is preferably permeable to alkaline solution, is transparent and about 4 μm to about 10 μm thick. This thickness, of course, can be modified depending upon the result desired. The dye diffusion transfer image receptor layer may also contain ultraviolet-absorbing materials to protect the mordanted dye images from fading, brightening agents such as the stilbenes, coumarins, triazines, oxazoles, dye stabilizers such as the chromanols, alkyl-phenols, etc.

### Electroless Deposition Catalysts

In a preferred embodiment of the security laminate according to the present invention, the dye diffusion transfer image receptor layer contains an electroless deposition catalyst.

The electroless deposition catalyst has several advantages including the thermal stabilization of the dye diffusion transfer image and the possibility of using the receptor layer also for silver diffusion transfer imaging where electroless deposition catalysts function as physical development nuclei.

The electroless deposition catalyst can also promote the carbonization of the polymeric mordant during laser marking, e.g. to create a ghost image. For this reason, especially stabilized Ag₂NiS₂ nuclei are preferred.

Suitable electroless deposition catalysts for use in the dye diffusion transfer image receptor layer are e.g. noble metal nuclei e.g. silver, palladium, gold, platinum, sulphides, selenides or tellurides of heavy metals such as Pd, Ag, Ni and Co. Preferred electroless deposition catalysts are colloidal PdS, Ag₂S or mixed silver-nickelsulphide particles.

The amount of electroless deposition catalyst used in the dye diffusion transfer image receptor layer is preferably between 0.02 mg/m² and 10 mg/m².

According to a particular embodiment the dye diffusion transfer image receptor layer is present on an electroless deposition catalyst-free underlying hydrophilic colloid undercoat layer or undercoat layer system having a coverage in the range of 0.1 to 1 g/m² of hydrophilic colloid.

The undercoat optionally incorporates substances that improve the image quality, e.g. incorporates a substance improving the image-tone or the whiteness of the image background. For example, the undercoat may contain a fluorescent substance, silver complexing agent(s) and/or development inhibitor releasing compounds known for improving image sharpness.

According to a special embodiment the image-receiving layer (1) is applied on an undercoat playing the role of a timing layer in association with an acidic layer serving for the neutralization of alkali of the image-receiving layer. By the timing layer the time before neutralization occurs is established, at least in part, by the time it takes for the alkaline processing composition to penetrate through the timing layer. Materials suitable for neutralizing layers and timing layers are disclosed in Research Disclosure July 1974, item 12331 and July 1975, item 13525.

In the dye diffusion transfer image receptor layer, gelatin is used preferably as hydrophilic colloid. Gelatin is present preferably for at least 60% by weight of the receptor layer is and is optionally used in conjunction with another hydrophilic colloid. e.g. polyvinyl alcohol, cellulose derivatives, preferably carboxymethyl cellulose, dextran, gallactomannans, alginic acid derivatives, e.g. alginic acid sodium salt and/or watersoluble polyacrylamides.

The dye diffusion transfer image receptor layer is may comprise colloidal silica.

### Supports

The support of the security laminate according to the present invention should be sufficiently thick to be self-supporting, but thin enough to be flexed, folded or creased without cracking. Preferably, support has a thickness of between about 7 μm and about 250 μm, more preferably between about 10 μm and about 150 μm, most preferably between about 20 μm and about 100 μm.

The support preferably comprises at least one layer, but can be a multilayered laminate or co-extrudate. Such multilayer laminates include paper/polymer laminates. Examples of suitable co-extrudates are PET/PETG and PET/PC.

The support for use in the present invention can be transparent, translucent or opaque, and can be chosen from paper type and polymeric type supports well-known from photographic technology.

Paper types include plain paper, cast coated paper, polyethylene coated paper and polypropylene coated paper. Synthetic paper, which is regarded to be a polymeric support may also be sued.

Polymeric supports include cellulose acetate propionate or cellulose acetate butyrate, polyesters such as polyethylene terephthalate and polyethylene naphthalate, polyamides, polycarbonates, polyimides, polyolefins, poly(vinylacetals), polyethers and polysulphonamides.

Other examples of useful high-quality polymeric supports for the present invention include opaque white polyesters and extrusion blends of polyethylene terephthalate and polypropylene.

Polyester supports and especially polyethylene terephthalate are preferred because of their excellent properties of dimensional stability. When such a polyester is used as the support material, a subbing layer may be employed to improve the bonding of the dye transfer receptor layer to the support. Useful subbing layers for this purpose are well known in the photographic art and include, for example, polymers of vinyl idene chloride such as vinylidene chloride/acrylonitrile/acrylic acid terpolymers or vinylidene chloride/methyl acrylate/itaconic acid terpolymers.

In a preferred embodiment of the security document according to the present invention, the support is polyvinyl chloride, polycarbonate or polyester, with coloured or whitened polyvinyl chloride, polycarbonate or polyester being preferred. The polyester support is preferably polyethylene terephthalate support (PET) or polyethylene terephthalate glycol (PETG).

Instead of a coloured or whitened support, an opacifying layer can be coated onto the support. Such opacifying layer preferably contains a white pigment with a refractive index greater than 1.60, preferably greater than 2.00, and most preferably greater than 2.60. The white pigments may be employed singly or in combination.

Suitable white pigments include C.I. Pigment White 1, 3, 4, 5, 6, 7, 10, 11, 12, 14, 17, 18, 19, 21, 24, 25, 27, 28 and 32. Preferably titanium dioxide is used as pigment with a refractive index greater than 1.60. Titanium oxide occurs in the crystalline forms of anatase type, rutile type and brookite type. In the present invention the rutile type is preferred because it has a very high refractive index, exhibiting a high covering power.

In one embodiment of the security document according to the present invention, the support is an opacified polyvinyl chloride, an opacified polycarbonate or an opacified polyester.

### Protective Layers

The security document precursor according to the present invention may be provided with at least one protective layer on top of at least the dye diffusion transfer image. Preferably the security document precursor will have several protective layers on top of each other, for example, each containing some information or security features applied by other type of imaging techniques such as ink-jet printing, intaglio printing, screen printing, flexographic printing, driographic printing, electrophotographic printing, electrographic printing, embossing and offset printing.

In one embodiment of the security document precursor according to the present invention, the at least one protective layer is sealed to at least the dye diffusion transfer image by an adhesive layer. More preferably, the at least one protective layer is sealed to the entire surface of the side of the support bearing the dye diffusion transfer image.

Suitable protective layers which are laminated or coated include cellulose acetate propionate or cellulose acetate butyrate, polyesters such as polyethylene terephthalate and polyethylene naphthalate, polyamides, polycarbonates, polyimides, polyolefins, polyvinylchlorides, polyvinylacetals, polyethers and polysulphonamides.

In a preferred embodiment of the security document according to the present invention, the protective layer is polyvinyl chloride, polycarbonate or polyester. The polyester is preferably polyethylene terephthalate (PET) or polyethylene terephthalate glycol (PETG).

### Methods of Securing and Manufacturing and Security Documents

Laser engraving or laser marking of a receptor layer with a dye diffusion transfer image in a security document precursor can be used to prevent or to identify falsification of a security document.

A method of manufacturing a security document precursor comprising the steps of:
providing a security laminate including a support and a dye diffusion transfer image receptor layer including a polymeric mordant for dyes;
applying a dye diffusion transfer image to the receptor layer of the security laminate; and
laser engraving the dye diffusion transfer image or laser marking the dye diffusion transfer image receptor layer.

In one embodiment of the method, the security laminate is first laminated on a security document precursor, preferably a laser marked security precursor, before laser engraving the dye diffusion transfer image or laser marking the dye diffusion transfer image receptor layer.

In another embodiment of the method, a dye diffusion transfer image in the dye diffusion transfer image receptor layer of the security laminate is first laser engraved or the dye diffusion transfer image receptor layer of the security laminate is first laser marked, before the security laminate is laminated on a security document precursor, preferably a laser marked security precursor.

Suitable laser marked security precursors are described in the next section.

Embodiments wherein both laser engraving of the dye diffusion transfer image and laser marking of the dye diffusion transfer image receptor layer occur are preferred for the methods according to the present invention.

In a preferred embodiment of the method, a second dye diffusion transfer image of uniform density, preferably having an optical density between 1.3 and 2.0, is laser engraved to obtain an inverted image of the first silver diffusion transfer image. An example is shown in FIG. 4.

The laser engraved and/or laser marked security laminate can be laminated on a security document precursor with the side of the support containing the receptor layer with the first dye diffusion transfer image. In such a case the support of the dye diffusion transfer image receptor layer is preferably a transparent support.

The laser engraved and/or laser marked security laminate can also be laminated on a security document precursor with the opposite side of the support containing the receptor layer with the first dye diffusion transfer image. However in such a case the dye diffusion transfer image receptor layer is preferably coated directly on the security document precursor rather than first coating the receptor layer on a support and then laminating it on the security document precursor.

In a special embodiment, the effect of laser marking is used to identify falsification of a security document. In this embodiment, a security laminate containing a support and a dye diffusion transfer image receptor layer including a polymeric mordant for dyes and containing a finely patterned dye diffusion transfer image, such as guilloches, is laminated on a laser marked security document precursor. In attempting falsification of the security document by laser marking additional information in the image of the laser marked security document precursor, the laser marking creates not only additional optical density in the dye diffusion transfer image receptor layer, but also discolours the finely patterned dye diffusion transfer image. The discolouration is not due to laser engraving, since it also occurs when a protective layer was applied on the receptor layer.

A preferred embodiment of a method of securing a laser marked security document precursor includes the steps of:
providing a security laminate including a support and a dye diffusion transfer image receptor layer including a polymeric mordant for dyes;
applying a patterned dye diffusion transfer image, such as guilloches, on the security laminate; and
applying a protective layer on the receptor layer with the patterned dye diffusion transfer image. Preferably the patterned dye diffusion transfer image includes guilloches.

Another embodiment of a method of securing a laser marked security document precursor includes the steps of:

providing a security laminate including a support and a dye diffusion transfer image receptor layer including a polymeric mordant for dyes;
applying a patterned dye diffusion transfer image, such as guilloches, on the security laminate; and
laminating the security laminate on the security document precursor with the side of the support containing the receptor layer with the first dye diffusion transfer image. In such a case the support of the dye diffusion transfer image receptor layer is preferably a transparent support. Preferably the patterned dye diffusion transfer image includes guilloches.

The above methods of securing and manufacturing a security document allow the securization of a security document which is simple to implement and makes it possible to reduce production costs.

### Laser Marked Security Document Precursors

The security laminate according to the present invention can be used to protect laser marked security document precursors as described by the methods above. Such a laser marked security document precursor, e.g. containing polycarbonate, has the property that it stays “alive”, i.e. additional information can be laser marked afterwards on the already laser marked security document precursor.

Laser marking produces a colour change in a laser markable layer through carbonization of the polymer in the layer caused by local heating. Patent literature and other literature contain contradictory statements regarding the necessity of specific “laser additives” for one polymer or another. This is presumably because particular additives which are regularly added to plastics for other purposes (for example as a filler, for colouring or for flame retardation) can also promote the laser marking result. The literature particularly frequently mentions polycarbonate, polybutylene terephthalate (PBT) and Acrylonitrile Butadiene Styrene (ABS) as “laser-markable even without additive”, but additives are often added even in the case of these polymers in order to improve the laser markability further.

The laser marked security precursor preferably includes at least one laser markable layer containing one or more polymers for laser marking. The at least one laser markable layer can be a self-supporting layer or a layer on a support.

### Polymers for Laser Marking

In the laser marked security document precursor, any polymer suitable for laser marking, i.e. by carbonization, may be used. Preferred polymers include polycarbonate (PC), polyethylene terephthalate (PET), polybutylene terephthalate (PBT), polyvinyl chloride (PVC), polystyrene (PS) and copolymers thereof, such as e.g. aromatic polyester-carbonate and acrylonitrile butadiene styrene (ABS). A mixture of two or more of these polymers may also be used.

In a particular preferred embodiment of the laser marked security document precursor includes contains polycarbonate or a copolymer thereof.

In order to promote and to support the colour change in polymeric materials, various additives have been developed. As a result of the addition of a “laser additive”, a substance which absorbs the laser light and converts it to heat, the heat input and the carbonization can be improved. This is the case even for polymers such as polycarbonate which carbonize readily on their own. Laser-markable plastics which are difficult to laser-treat include polyethylene, polypropylene, polyamide, polyoxymethylene, polyester, polymethyl methacrylate, polyurethane or a copolymer thereof.

### Laser Additives

Suitable laser additives include antimony metal, antimony oxide, carbon black, mica (sheet silicate) coated with metal oxides and tin-antimony mixed oxides. In WO 2006/042714 (TICONA), the dark coloration of plastics is obtained by the use of additives based on various phosphorus-containing mixed oxides of iron, copper, tin and/or antimony.

In a preferred embodiment, the laser marked security document precursor contains carbon black particles. This avoids the use of heavy metals, which are less desirable from an ecology point of view, in manufacturing these security documents, but may also cause problems for persons having a contact allergy based on heavy metals.

Suitable carbon blacks include Pigment Black 7 (e.g. Carbon Black MA8™ from MITSUBISHI CHEMICAL), Regal™ 400R, Mogul™ L, Elftex™ 320 from CABOT Co., or Carbon Black FW18, Special Black 250, Special Black 350, Special Black 550, Printex™ 25, Printex™ 35, Printex™ 55, Printex™ 90, Printex™ 150T from DEGUSSA.

The use of these laser additives may lead to an undesired background colouring of the security document. For example, a too high concentration of carbon black in a laser markable layer based on polycarbonate leads to grey security documents. If a white background is requested for the security document, then a white pigment may be added to the composition for manufacturing the laser markable layer. Preferably a white pigment with a refractive index greater than 1.60 is used. A preferred pigment is titanium dioxide.

### Laser Marking and Laser Engraving

Laser engraving and laser marking can be performed with the same type of laser. Depending on the composition of material which is exposed to the laser, either an effect occurs involving carbonization of material (=laser marking) or an effect is observed wherein material is ablated (=laser engraving).

Laser engraving is performed on the dye diffusion transfer image, while laser marking is performed in the dye diffusion transfer image receptor layer in an area where no dye diffusion transfer image is present.

The laser used in the laser engraving or laser marking can be any laser as long as it is able to form an image by ablation respectively carbonization.

In order to carry out the laser engraving or laser marking with high speed, a laser having a high power is desirable. One preferred example of such a laser is a laser having an emitting wavelength in an infrared region or near infrared region, for example, a carbon dioxide gas laser, a YAG laser, a semiconductor laser or a fiber laser. An ultraviolet laser having an emitting wavelength in an ultraviolet region, for example, an excimer laser, a YAG laser wavelength-converted to the third harmonic or the fourth harmonic or a copper vapour laser may also be used. A laser having an extremely high peak power, for example, a femtosecond laser can also be employed. The laser irradiation may be performed continuously or pulse wise.

Preferred lasers for laser engraving in the present invention are CO₂-lasers and Nd-YAG lasers. Fiber lasers can also be used.

Although laser engraving is usually conducted under oxygen-containing gas, ordinarily in the presence of air or in airflow, it can be conducted under carbon dioxide gas or nitrogen gas.

### Other Security Features

To prevent forgeries of identification documents, different means of securing are used. One solution consists in superimposing lines or guilloches on an identification picture such as a photograph. In that way, if any material is printed subsequently, the guilloches appear in white on added black background. Other solutions consist in adding security elements such as information printed with ink that reacts to ultraviolet radiation, micro-letters concealed in an image or text etc.

The security document according to the present invention may contain other security features such as anti-copy patterns, guilloches, endless text, miniprint, microprint, nanoprint, rainbow colouring, 1D-barcode, 2D-barcode, coloured fibres, fluorescent fibres and planchettes, fluorescent pigments, OVD and DOVID (such as holograms, 2D and 3D holograms, Kinegrams™, overprint, relief embossing, perforations, metallic pigments, magnetic material, Metamora colours, microchips, RFID chips, images made with OVI (Optically Variable Ink) such as iridescent and photochromic ink, images made with thermochromic ink, phosphorescent pigments and dyes, watermarks including duotone and multitone watermarks, ghost images and security threads.

A combination with one of the above security features increases the difficulty for falsifying a security document.

### EXAMPLES

### Materials

All materials used in the following examples were readily available from standard sources such as ALDRICH CHEMICAL Co. (Belgium) and ACROS (Belgium) unless otherwise specified. The water used was deionized water.

Antimoussol™ WLN is a polyethylene glycol available from SANDOZ. Tinuvin™ 109 is a mixture of Octyl-3-[3-tert-butyl-4-hydroxy-5-(5-chlor-2H-benzotriazolel-2-yl)phenyl]propionate and 2-ethylhexyl-3-[3-tert-butyl-4-hydroxy-5-(5-chloor-2H-benzotriazole-2yl)phenyl]propionate, i.e. CASRN 83044-89-7 and CASRN 83044-90-0, available from CIBA. GALORYL™ MT 805 is an alkylaryl sulphonate available from COMPAGNIE FRANCAISE DE PRODUITS INDUSTRIELS NUFARM with the following structure:

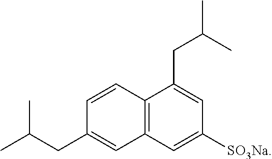

1,3-bis(hydroxymethyl)ureum is available from BASF.

SILQUEST™ A178 is a mixture of mixture of trimethoxy silane and tri-ethoxy silane available from GE SILICONES of Wilton, Conn.

Type Nr 006 PET (P063C S/AS) is a 63 μm subbed clear PET substrate with on the backside an antiblocking layer with antistatic properties available from AGFA GEVAERT.

Gelita™ 69077 is a calcium-free photographic gelatin available from GELITA AG (Eberbach).

Gelita™ 69085 is a calcium-free photographic gelatin available from GELITA AG (Eberbach).

Proxel™ Ultra 5 is 1,2-benzthiazole-3(2H)-one, a biocide from AVECIA.

### Measurement Methods

### 1. Optical Density

The optical density (OD) was measured with a spectrodensitometer Type 504 from the X-RITE using a visual filter.

### 2. Numeric Average Particle Diameter

The determination of the numeric average particle diameter was performed by photon correlation spectroscopy at a wavelength of 633 nm with a 4 mW HeNe laser on a diluted sample of the dispersion. The particle size analyzer used was a Malvern™ nano-S available from Goffin-Meyvis. The measured particle size is the average value of 3 consecutive measurements consisting of 6 runs of 20 seconds.

### Example 1

This example illustrates the laser engraving of a dye diffusion transfer image.

### Preparation and Evaluation

For the inventive example INV-1, a dye diffusion transfer colour image was made on the image-receiving material (coupon) from the Anaïs M.10 system available from AGFA-GEVAERT NV.

For a comparison example COMP-1, the same colour image was printed on a New Pebble Mag™-printer from EVOLIS on a white PVC-card “Classic blank white card P/N C4001” from EVOLIS without applying a varnish layer.

For a comparison example COMP-2, the same colour image was printed on the opaque acceptor Drystar™ TS 2 O using a Drystar™ TS 2 CF ribbon in an Agfa Drystar 2000 printer of AGFA HEALTHCARE NV.

The optical density (OD) of several comparable areas in the colour image of the inventive example INV-1 and the comparison examples COMP-1 and COMP-2 was measured with a spectrodensitometer Type 504 from the X-RITE using a visual filter.

The measured areas in the colour image of the inventive example INV-1 and the comparison examples COMP-1 and COMP-2 were then exposed with a Rofin RSM 10 E NdVO4 laser at setting 29 Ampere and at a frequency of 22 kHz.

The optical density of the same areas in the colour image of the inventive example INV-1 and the comparison examples COMP-1 and COMP-2 were then again measured. The results are shown in Table 1.

TABLE 1

| | | |
|---|---|---|
| | | Change after |
| Image | OD before | Laser Exposure |

| area | Example | Laser Exposure | OD | % |
|---|---|---|---|---|
| Face | COMP-1 | 0.68 | 1.03 | 51% |
| | COMP-2 | 0.60 | 0.60 | 0% |
| | INV-1 | 0.68 | 0.33 | −51% |
| Black | COMP-1 | 1.62 | 1.94 | 20% |
| colour | COMP-2 | 2.17 | 2.17 | 0% |
| | INV-1 | 1.87 | 1.18 | −37% |

From Table 1, it should be clear that laser engraving is possible on a dye diffusion transfer image as illustrated by the reduction of optical density in inventive example INV-1. For the thermal dye sublimation example COMP-1, an increase in optical density was observed which in certain cases may facilitate the falsification of a security document. In the thermal dye sublimation example COMP-2, no change in optical density is observed.

Also images produced by dye based inkjet printing, which together with thermal dye sublimation printing represents the most commonly used technique for manufacturing colour images in security documents, could not be laser engraved.

This is exemplified by comparative example COMP-3 wherein a water based Grand Sherpa AM black dye inkjet ink from Agfa Graphics NV was coated with a 10 μm barcoater on a HP Premium Inkjet Transparency Film from Hewlett-Packard, glued on a 500 μm PETG substrate and then exposed with a Rofin RSM 10 E NdVO4 laser at setting 29 Ampere and at a frequency of 22 kHz. An optical density before and after laser engraving of 1.01 respectively 1.05 was measured, i.e. no laser engraving was observed.

### Example 2

This example illustrates that a dye diffusion transfer image receptor layer including a polymeric mordant for dyes can be laser marked.

### Preparation and Evaluation

### Synthesis of Polymeric Mordant P-1

The polymeric mordant P-1 was synthesized according to the following synthesis scheme:

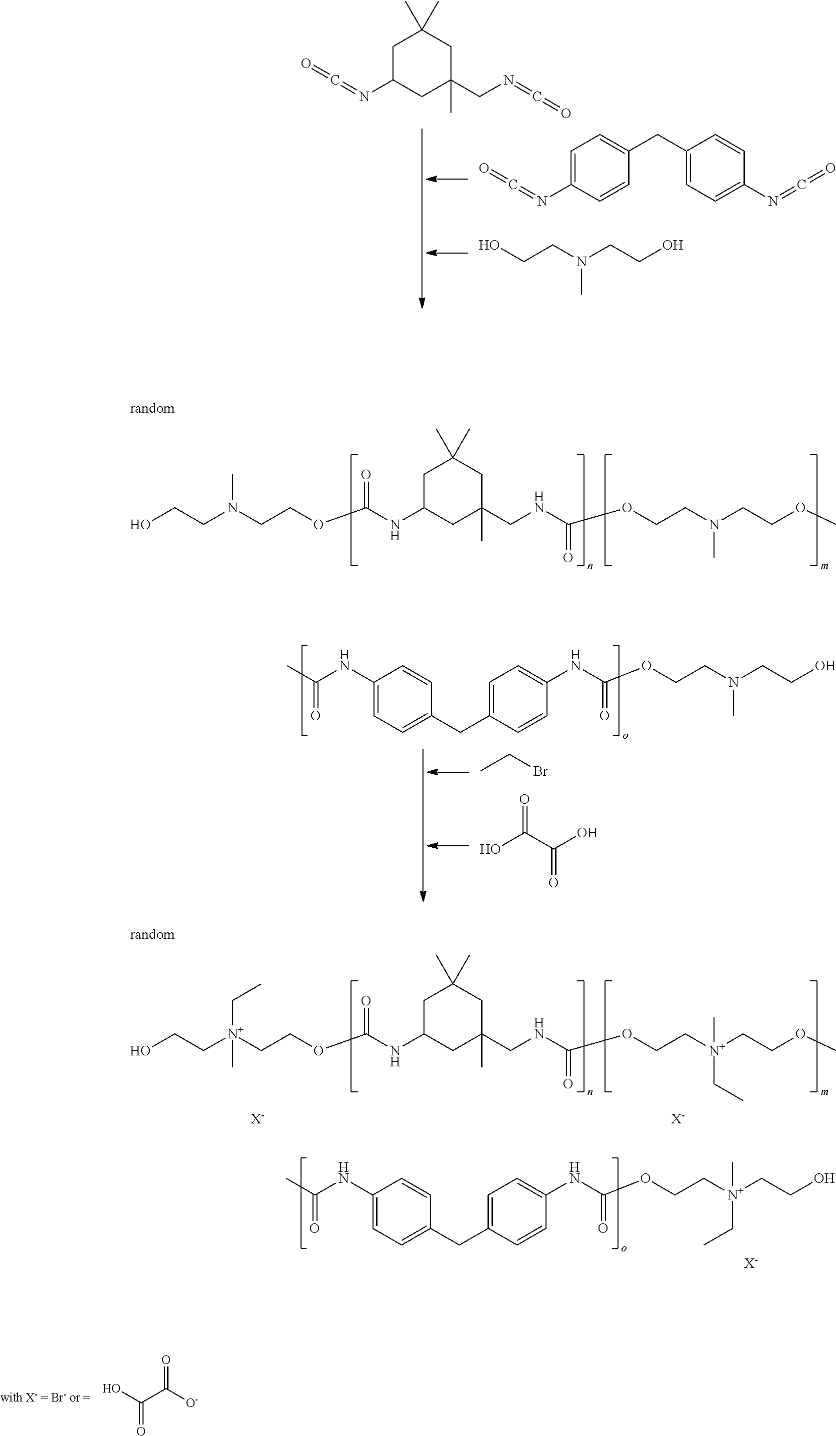

A reactor was filled with 18.6 kg of N-methyldiethanolamine and 272 L of ethyl acetate. Under stirring the mixture was heated to 60° C. 10.0 kg of diphenylmethane diisocyanate and 24.0 kg of isophoron diisocyanate were added under stirring and refluxed for 24 h at 78° C. Then 49 L of methanol was added. The reaction mixture was heated to 78° C. and 11.9 kg of ethyl bromide was added and stirring was continued for 16 h. The reactor content was cooled to 40° C. 50 L of ethyl acetate was added. Stirring was stopped and the resulting turbid top layer was removed. An aqueous solution of 4.6 kg oxalic acid dihydrate in 217 L of water was added. Methanol and the azeotrope ethylacetate/water were removed by vacuumdestillation. The product was filtered over a Seitz pressure filter. A 20.8 wt % solution of the polymeric mordant P-1 in water was obtained.

### Preparation of a Dispersion of Electroless Deposition Catalyst EDC-1

The electroless deposition catalyst EDC-1 is a Ag₂NiS₂ catalyst made from mixing three aqueous solutions A, B and C.

8.400 kg of Gelita™ 69085 gelatin was dissolved at 40° C. in 189.950 L of water. Then 0.168 L of Antimoussol™ WLN and 13.530 L of a 10% aqueous solution of sodium sulphide were added to complete solution A.

An aqueous solution N1 was made by dissolving of 1940 g of nickel nitrate in 8970 mL of water. An aqueous silver nitrate solution S1 was made containing 500 g of silver nitrate per liter. Solution B was made by mixing 7.350 L of N1 and 0.462 L of S1 in 202.188 L of water.

A solution F1 was made by mixing 2.000 kg of phenol in 8.000 L of ethanol. 20.000 kg of Gelita™ 69085 gelatin was dissolved at 40° C. in 78.620 L of water. 4.500 L of the solution F1 was diluted with 4.500 L of water and the mixture was to the gelatin solution to complete solution C.

The solutions A, B and C were all kept at a temperature of 40° C.

The electroless deposition catalyst EDC-1 was prepared by simultaneous addition of solutions A and B at a flow rate of 2.00 L/min to solution C under stirring at 200 rotations per minute. After the precipitation was completed mixing continued for 2 h at 50° C. The dispersion was cooled and discharged in containers of 20 L, wherein gelation of the dispersion occurred.

### Preparation of Whitener Dispersion WD-1

52.5 g of gelatin Gelita™ 69085 was dissolved at 50° C. under stirring in 556.9 mL of water. 17.5 g of a 20 wt % solution of Galoryl™ MT 805 in water, which had been adjusted with sulphuric acid to a pH of 9.0, was added to the gelatin solution. Next, 3.1 g of 5 wt % solution of Proxel™ Ultra 5 was added to the gelatin solution. The mixture was stirred at 50° C. for 30 minutes.

A solution of 70.0 g Tinuvin™ 109 was made in 140.0 g of ethylacetate under stirring and heating to 50° C. for 1 h. The Tinuvin™ 109 solution was then added to the gelatin solution and dispersed using a HOMO-REX™ High-speed Homogenizing mixer from BROGTEC MISCHTECHNIK GmbH. The dispersion was heated to 60° C. and further homogenized by one passage through a Microfluidizer™ from MICROFLUIDICS at 300 bar.

The ethyl acetate was removed at 600 to 675 mbar with a Rotavapor™ from BUCHI Laboratory Equipment. The resulting dispersion WD-1 had a pH of 6.1, a numeric average particle diameter of 202 nm measured by photon correlation spectroscopy and a dry weight content of 16.9 wt % based on the total weight of the dispersion.

### Preparation of Coated Sample DTR1

First a coating composition CS1 was prepared. 46.8 g of Gelita™ 69077 was dissolved at 45° C. under stirring in 524.5 mL of water.

100.0 g of the whitener dispersion WD-1 and 100.0 g of the dispersion of the electroless deposition catalyst EDC-1 were added to the gelatin solution and stirred for 1 h at 45° C. 175.0 mL of water was added.

20 mL of nonylfenoxy(polyethoxy)ethanol having a MW of 616 g was dissolved in 175 mL of water and added to the gelatin solution.

133 mL of the 20.8 wt % solution of the polymeric mordant P-1 in water was added and the coating composition was stirred for 30 minutes. 0.93 g of 1,3-bis(hydroxymethyl)ureum dissolved in 20 mL of water was added, followed by the addition of 25 mL of 10 wt % solution of SILQUEST™ A178 in ethanol to complete the coating composition CS1.

The dye diffusion transfer receptor layer was coated at 45′C. at a coating thickness of 52 μm on the subbing layer of a 63 μm Type Nr 006 PET substrate and dried.

### Evaluation

The optical density of the dye diffusion transfer receptor layer on the coated sample DTR1 was measured to be 0.16. The sample DTR1 was then uniformly exposed with a Rofin RSM 10 E NdVO4 laser at setting 29 Ampere and at a frequency of 22 kHz to produce a square of equal density. The OD measured was 0.28. Such an increase in optical density of only 0.12 makes it possible to make “ghost images”.

1-15. (canceled)

16. A security laminate comprising a dye diffusion transfer image receptor layer comprising a polymeric mordant for dyes on a support which includes a laser-engraved first dye diffusion transfer image or a laser-marked dye diffusion transfer image receptor layer in an area lacking the first dye diffusion transfer image.

17. The security laminate according to claim 16, wherein the polymeric mordant includes quaternary ammonium groups.

18. The security laminate according to claim 16, wherein the receptor layer further comprises an electroless deposition catalyst.

19. The security laminate according to claim 16, further comprising a ghost image or an inverted ghost image by laser-marking in an area of the receptor layer lacking the first dye diffusion transfer image.

20. The security laminate according to claim 16, wherein the first dye diffusion transfer image is laser-engraved with an image differing from the first dye diffusion transfer image.

21. The security laminate according to claim 20, wherein the image made by laser-engraving includes microprint or nanoprint.

22. The security laminate according to claim 16, wherein the support includes a second dye diffusion transfer image of uniform density which is laser-engraved with the inverted image of the first dye diffusion transfer image.

23. The security laminate according to claim 22, wherein the laser-engraved inverted image is located in the first dye diffusion transfer image.

24. A security document precursor comprising the security laminate as described by claim 1.

25. The security document precursor according to claim 24, wherein the security laminate is laminated on a laser-marked security document precursor.

26. The security document precursor according to claim 25, wherein the laser-marked security document precursor is laser-marked in a layer comprising a laser-marking additive and one or more polymers selected from the group consisting of polycarbonate, polyethylene terephthalate, polybutylene terephthalate, polyvinyl chloride, polystyrene and copolymers thereof.

27. A method of manufacturing a security document precursor comprising the steps of:
(a) providing a security laminate as defined by claim 1; and
(b) laminating the security laminate on the security document precursor with the side of the support containing the receptor layer with the first dye diffusion transfer image.

28. The method according to claim 27, wherein the receptor layer contains an electroless deposition catalyst.

29. A method of securing a laser-marked security document precursor comprising the steps of:
(a) providing a security laminate comprising a support and a dye diffusion transfer image receptor layer including a polymeric mordant for dyes;
(b) applying a patterned dye diffusion transfer image on the security laminate; and
(c) laminating the security laminate on the laser-marked security document precursor.

30. The method according to claim 29, wherein the receptor layer contains an electroless deposition catalyst.
